(19) United States
(12) Patent Application Publication
(10) Pub. No.: US 2025/0263102 A1
(43) Pub. Date: Aug. 21, 2025

(54) SOLAR AIR STROLLER

(71) Applicant: Apryl Bell, Detroti, MI (US)

(72) Inventor: Apryl Bell, Detroti, MI (US)

(21) Appl. No.: 19/002,582

(22) Filed: Dec. 26, 2024

Related U.S. Application Data
(63) Continuation of application No. 17/453,372, filed on Nov. 3, 2021, now abandoned.

(51) Int. Cl. B62B 7/14; B62B 9/14

(52) U.S. Cl. CPC B62B 7/14; B62B 9/142; B62B 2204/04

(57) ABSTRACT

A stroller includes a frame having a shaft, a seat depending from the frame, a base disposed on the frame, and wheels disposed on the base. The shaft of the frame is inserted into the base to allow the frame to rotate relative to the base. In another possible approach, a stroller includes a frame, a seat depending from the frame, a base disposed on the frame, a canopy extending from the seat, and a display device incorporated into the canopy. The display device is viewable from the seat and display entertainment and educational content based on signals received from an app on a mobile device.

### CROSS-REFERENCE TO RELATED APPLICATIONS

This patent application is a Continuation of U.S. patent application Ser. No. 17/453,372 filed on Nov. 3, 2021. U.S. patent application Ser. No. 17/453,372 claims priority to and all advantages of, U.S. Provisional Patent Application No. 63/109,245 filed on Nov. 3, 2020 and U.S. patent application Ser. No. 63/136,116 filed on Jan. 11, 2021, the contents of both of which are incorporated herein by reference in their entireties.

### BACKGROUND

Strollers make it easy for parents to transport children, especially when the alternative is to carry the child a long distance or walk at a slow pace. It is common to see parents pushing children in strollers at grocery stores, parks, malls, zoos, playgrounds, and other places. Beyond making it easy to transport children, strollers often have storage compartments that parents can use to transport a diaper bag and other personal items.

### BRIEF DESCRIPTION OF THE DRAWINGS

FIG. 1 illustrates an example stroller with features that improve the comfort of the stroller to a child.

FIG. 2 is a side view of the stroller of FIG. 1 showing a swivel feature and wheel locks.

FIG. 3 is an inside view of a canopy of the stroller of FIG. 1 having a cooling fan.

FIG. 4 is a side view of the canopy of FIG. 3 showing the cooling fan and a solar panel.

FIG. 5 is a perspective view of a stroller having a display device.

FIG. 6 is a front view of the display device used in the stroller of FIG. 5.

FIG. 7 illustrates an example stroller having skis.

FIGS. 8A-8B illustrates example screenshots of an app that may be used to entertain a child in the stroller.

### DETAILED DESCRIPTION

While strollers make it easy for parents to transport their children, spending extended periods of time in stroller can be uncomfortable for the child. For example, some strollers inhibit airflow, which can make the child feel hot and uncomfortable. Another issue is that the child may experience boredom while riding in the stroller. The lack of comfort or the feeling of boredom may cause some children to become disruptive.

Another issue with conventional strollers is their inability to adapt to different types of terrain and environments. For many parents, this means having to purchase multiple strollers or limiting use of the stroller to certain activities or locations.

One way to address these issues is with a stroller that increases child comfort, reduces boredom, and/or is configurable to accommodate different terrains. For instance, a stroller may include a frame having a shaft, a seat disposed on the frame, a base disposed on the frame, and wheels disposed on the base. The shaft of the frame is inserted into the base to allow the frame to rotate relative to the base. In some cases, the base or the wheels may be replaced with skis.

In another possible approach, a stroller includes a frame, a seat disposed on the frame, a base disposed on the frame, a canopy extending from the seat, and a display device incorporated into the canopy. The display device is viewable from the seat to help educate or entertain a child in the stroller.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

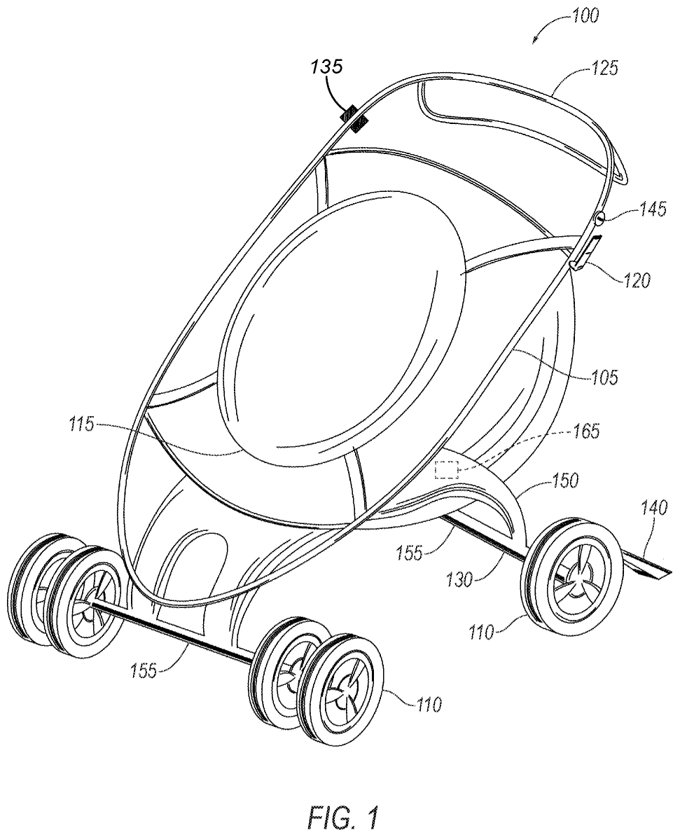

FIG. 1 illustrates an example stroller 100 with features that improve the comfort of the stroller 100 to a child, as well as makes the stroller 100 more convenient for adults pushing the stroller 100. The stroller 100 of FIG. 1 includes a frame 105, wheels 110, a seat 115, a swivel lock 120, a handlebar 125, a foot bar 130, a storage compartment 135, a wheel lock 140, and a communication port 145.

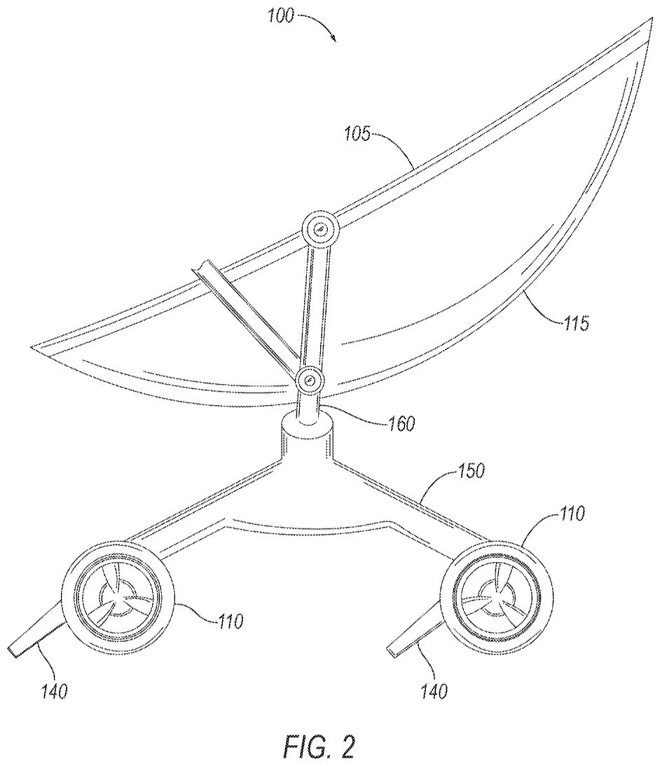

The frame 105 may generally support other components of the stroller 100. In some instances, the frame 105 is formed from one or more pieces of metal, plastic, rubber, or materials. For example, the frame 105 may be formed from aluminum, alone or in combination with other materials. As discussed in greater detail below with respect to FIG. 2, the frame 105 may be mounted to a base 150 in a way that allows the seat 115 to swivel.

The wheels 110 may attach to the base 150 to facilitate lateral movement of the stroller 100. The wheels 110 may be circular and formed from plastic or rubber. In some instances, the wheels 110 may attach to axles 155 attached to or integrated into the base 150. When installed on the axles 155, the wheels 110 may rotate when the stroller 100 is pushed.

The seat 115 may be disposed on the frame 105. The seat 115 may have a generally concave configuration and may be padded for comfort. For instance, the seat 115 may be formed from relatively soft materials such as foam with a cover made from a fabric such as cotton, a synthetic material, or a blend of materials. The cover may be waterproof, removable, and/or machine-washable. The seat 115 may be mounted on the frame 105 above the base 150 so that the seat 115 does not inhibit the frame 105 from rotating about the base 150.

The swivel lock 120 may be a mechanical lock that prevents the frame 105 from swiveling relatively to the base 150. That is, the swivel lock 120 may lock the seat 115 in its orientation relative to the base 150 at the time the swivel lock 120 is engaged. In another possible implementation, the swivel lock 120 may lock the seat 115 in a particular orientation, such as either forward facing, rear facing, or both, when the swivel lock 120 is engaged. The swivel lock 120 may include an actuator that increases pressure between the frame 105 and the base 150. The increase in pressure may prohibit the frame 105 from rotating relative to the base 150. For instance, the actuator may include a lever that rotates between a first position and a second position. When in the first position, the lever applies a nominal force to a shaft 160 (see FIG. 2) extending into the base 150, thereby allowing the frame 105 and the seat 115 to rotate relative to the base 150. When in the second position, the lever applies a force to the shaft 160 sufficient to limit rotational movement of the seat 115 relative to the base 150. Thus, moving the actuator from the first position to the second position may lock the seat 115.

A handlebar 125 may be attached to or integrally formed with the frame 105. In some instances, the handlebar 125 is located at or near the top of the frame 105 to make it easier for a person to push the stroller 100. The handlebar 125 may further permit rotation of the frame 105 relative to the base 150 when, e.g., the swivel lock 120 is unlocked (e.g., in the first position).

A foot bar 130 may be located at or near the bottom of the frame 105 or on the base 150. The foot bar 130 may serve as a footrest or to give the person pushing the stroller 100 additional leverage when pushing the stroller 100 in rough terrain or when slightly tilting the stroller 100 onto an elevated surface such as over a curb to get onto a sidewalk. In some instances, one of the axles 155 may serve as the foot bar 130.

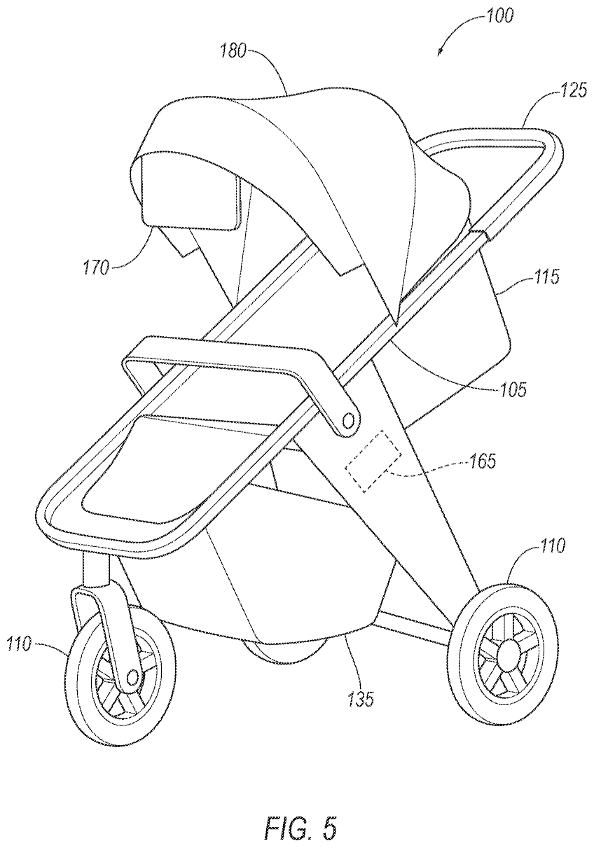

The storage compartment 135 (see FIG. 5) may be attached or integrated into the frame 105, the base 150, or the seat 115. The storage compartment 135 may be used to hold small items. In some instances, the storage compartment 135 is a pouch or pocket. In other instances, the storage compartment 135 includes one or more cup holders, cell phone holders, or the like.

The wheel lock 140 may be attached or integrated into the base 150 and/or the foot bar 130. The wheel lock 140 may be actuated to lock one or more of the wheels 110. In some instances, the wheel lock 140 includes a lever that, when actuated, prevents one or more wheels 110 from rotating. Therefore, actuating the wheel lock 140 prevents the stroller 100 from moving.

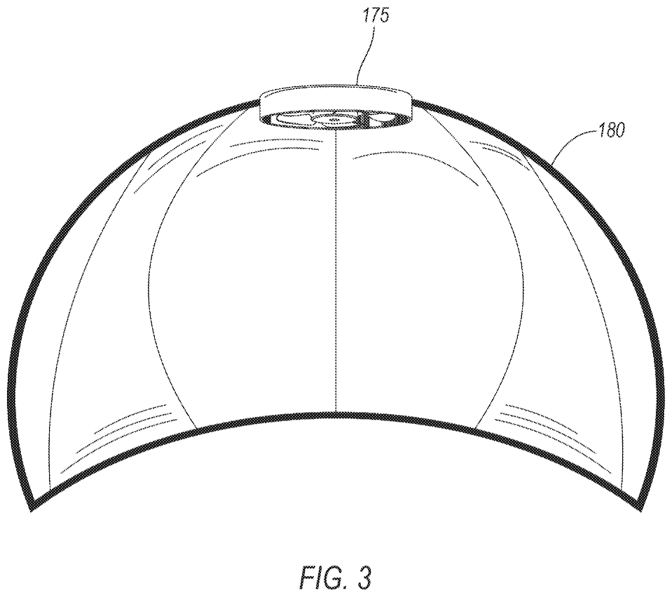

The communication port 145 may include a device interface such as a universal serial bus (USB) interface. When an electronic device is plugged into the communication port 145, the electronic device may receive power from a battery 165 (see FIG. 5) or other power supply located on the frame 105 or the base 150. Moreover, as discussed in greater detail below with respect to FIG. 5, the communication port 145 may be used to connect a mobile device, such as a smartphone, to a built-in display device 170 or to power the cooling fan 175 (see FIG. 3).

FIG. 2 is a side view of the stroller 100 of FIG. 1 showing how the frame 105 may swivel or rotate relative to the base 150, as well as additional wheel locks 140 that may be used to lock multiple wheels 110 in place. As shown in FIG. 2, the frame 105 includes a shaft 160 that extends into the base 150. The shaft 160 allows the frame 105 to rotate relative to the base 150. The rotation of the frame 105 causes the seat 115 to rotate since the frame 105 and seat 115 are fixed relative to one another.

FIG. 3 is an inside view of a canopy 180 of the stroller 100 of FIG. 1 having a cooling fan 175. The canopy 180 may provide shade while the cooling fan 175 may provide additional comfort to a child in the seat 115.

The canopy 180 may be folded into the seat 115 when not in use. When shade or cooling are desired, the canopy 180 may be manually extended or unfolded from a top of the seat 115. The canopy 180 may be formed from a fabric material, which may or may not be the same material as the seat 115. In some instances, the canopy 180 may be formed from plastic. The canopy 180 may further or alternatively include structural supports so that the canopy 180 may be cantilevered at least partially over the area where the child is located in the seat 115. The structural supports may be part of the frame 105 or different from the frame 105. The canopy 180 may be integrally formed with the seat 115 or otherwise attached to the seat 115 or the frame 105.

The cooling fan 175, incorporated into the canopy 180, is electrically powered and pushes air toward the child located in the child seat 115. The cooling fan 175 is powered by an on-board battery 165 (see FIG. 5), the user's mobile device plugged into the communication port 145, or another power supply. The cooling fan 175 may include an activation switch. When turned to an ON position, the activation switch may energize a motor that causes the fan to rotate. When turned to an OFF position, the activation switch may disconnect the cooling fan 175 from the battery 165 or other power supply. The cooling fan 175 may include a grill, mesh, or other cover to, e.g., protect the fan blades and to reduce the risk of hair snags, finger injuries, or the like.

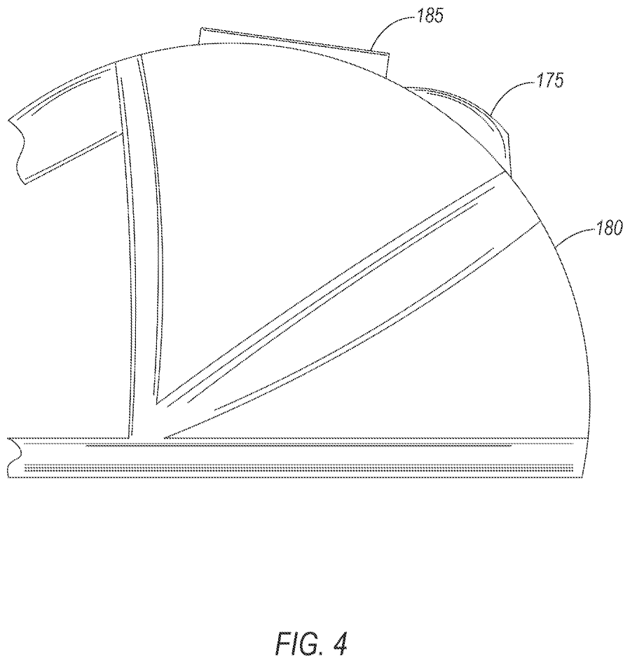

FIG. 4 is a side view of the canopy 180 of FIG. 3, extending over a portion of the seat 115, and showing the cooling fan 175 and a solar panel 185. The solar panel 185 may be used to collect sunlight and charge the on-board battery 165. In other words, the solar panel 185 converts sunlight into electrical energy that can be stored in the battery 165.

FIG. 5 is a perspective view of a stroller 100 having a display device 170 incorporated into the canopy 180. When the canopy 180 is extended, the display device 170 may be viewable from the seat 115. That way, the child in the seat 115 may view content presented on the display device 170. In some possible implementations, the display device 170 is powered by a battery 165 or another type of power supply. When in use, the display device 170 may draw electrical energy from the battery 165.

The battery 165 may provide direct current electrical energy to the display device 170 or other devices. The battery 165 may be directly electrically connected to the display device 170. The battery 165 may be electrically connected to other electronic devices, such as a user's cell phone, through the communication port 145 discussed above.

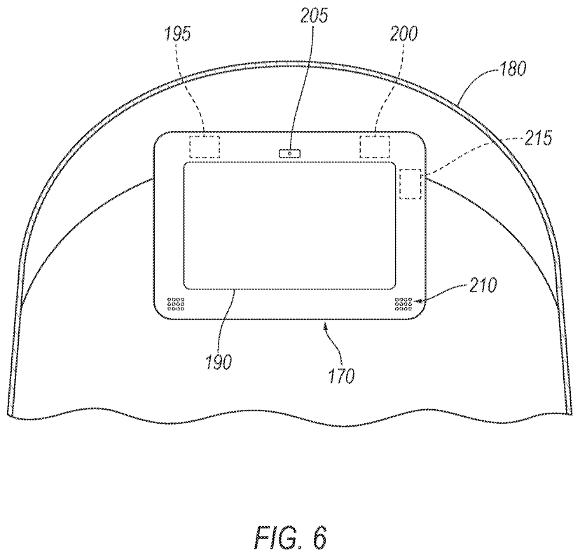

FIG. 6 is a front view of the display device 170 used in the stroller 100 of FIG. 5. The display device 170 may include a screen 190, memory 195, communication interface 200, a camera 205, speakers 210, and a processor 215.

The screen 190 may be an LCD, OLED, or other type of screen 190 that can output signals. The screen 190 may be configured to display text, images, video, etc., to the person sitting in the seat 115 of the stroller 100. The content displayed by the screen 190 may be stored in the memory 195 or streamed from, e.g., a mobile device connected to the display device 170 through the communication interface 200, the communication port 145, or a combination thereof. In some instances, the screen 190 may be configured to display content streamed from a remote server via the communication interface 200.

The memory 195 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory 195 may store instructions executable by the processor 215 and data such as the content displayed to the child in the stroller 100. The instructions and data stored in the memory 195 may be accessible to the processor 215 and possibly other components of the stroller 100.

The communication interface 200 is implemented via an antenna, circuits, chips, or other electronic components that facilitate wireless communication between the display device 170, the communication port 145, wireless access points, cellular towers, or the like. Components of the communication interface 200 may be programmed to communicate in accordance with any number of wired or wireless communication protocols. For instance, the components of the communication interface 200 may be programmed to communicate in accordance with a satellite-communication protocol, a cellular-based communication protocol (5G, LTE, 3G, etc.), Bluetooth®, Bluetooth® Low Energy, Ethernet, the Controller Area Network (CAN) protocol, WiFi, the Local Interconnect Network (LIN) protocol, etc.

The camera 205 is a vision sensor. The camera 205 may capture images of the child sitting in the seat 115 of the stroller 100. To capture such images, the camera 205 may include a lens that projects light toward, e.g., a CCD image sensor, a CMOS image sensor, etc. The camera 205 processes the light and generates the image. The image may be output to the processor 215 and, as discussed in greater detail below, can be used to record or monitor the child in the seat 115 and/or display the image of the child in the seat 115 on the display device 170.

The speakers 210 may be implemented by one or more electroacoustic transducers that convert electrical signals into audible sound. Signals received by the speakers 210 cause the transducers to vibrate. As such, the speakers 210 may play sounds associated with the content being displayed on the display device 170. In some instances, the speakers 210 may be operated independently of the display device 170. That is, the speakers 210 may play audio from a user's mobile device in wired or wireless communication with the display device 170.

The processor 215 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The processor 215 can execute instructions that control the operation of the screen 190, the memory 195, the communication interface 200, the camera 205, the speakers 210, and any other component of the display device 170.

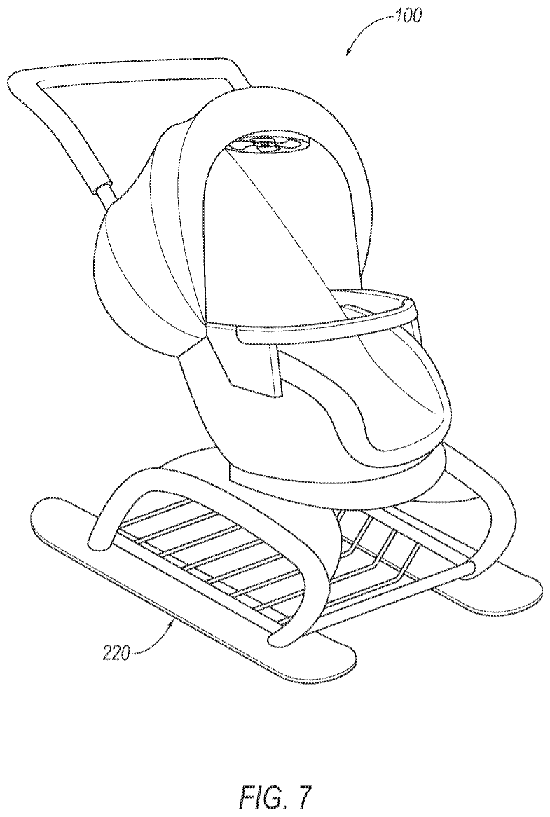

FIG. 7 illustrates an example stroller 100 having removable skis 220. The skis 220 may replace the base 150 and wheels 110 in certain circumstances, such as when there is snow on the ground. In such cases, the base 150 may be removed and replaced with the skis 220. When the skis 220 are installed, the stroller 100 may be easily pushed on snowy surfaces. The skis 220 may be installed by lifting the frame 105 off the base 150 and installing the frame 105 onto the skis 220. The opposite sequence may be used to reinstall the base 150 with the wheels 110. That is, the skis 220 may be removed from the frame 105, and the base 150 with the wheels 110 may be reinstalled onto the frame 105.

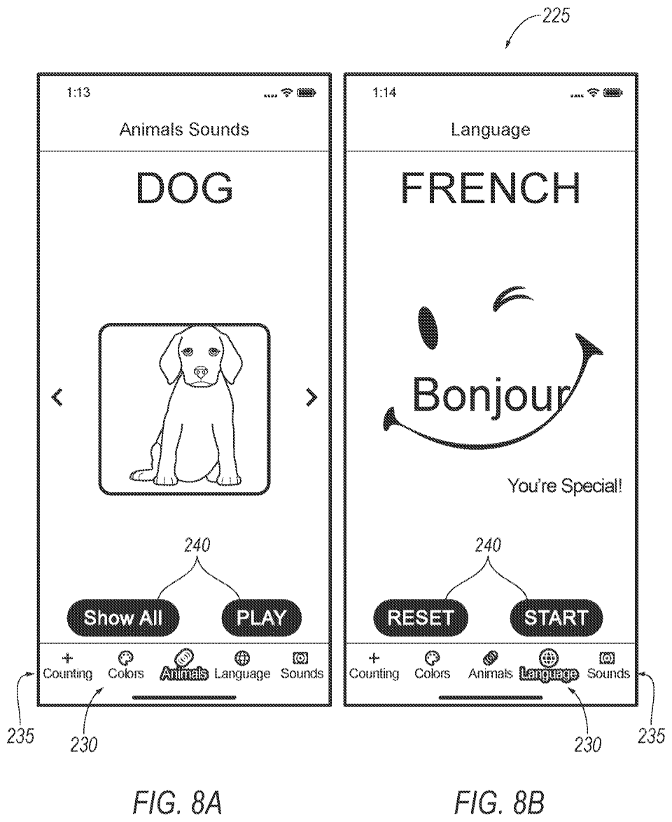

FIGS. 8A-8B illustrates example screenshots of an app 225 that may be used to entertain the child in the stroller 100. The app 225 may provide educational and/or entertaining content to the child. The content of the app 225 may be presented to the child via the display device 170. The app 225 may present educational and/or entertaining content related to counting or mathematical skills, colors, animals, language, or sounds.

The app 225 may have a graphical user interface that includes touch-screen controls 230. The controls may include a navigation bar 235 with virtual buttons that allow the user to navigate the different educational and/or entertaining content options. The controls 230 may further include contextual buttons 240 that change depending on the educational and/or entertaining content being shown. In FIGS. 8A and 8B, the contextual buttons 240 may include, e.g., “show all” to show all images, “play” to play an animal sound, “reset” to restart a language lesson, or “start” to start a language lesson.

In the example shown in FIG. 8A, the app 225 displays a picture of an animal (e.g., a dog) on the display screen 190. A sound associated with the animal (e.g., a dog barking) may be played through the speakers 210. By using the app 225 while riding in the stroller 100, the child may begin to associate animals with the sounds the animal makes. In the example of FIG. 8B, the child is exposed to another language (e.g., French). In this example, the child is shown words in French along with their English translation.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the OS X, macOS, and iOS operating systems distributed by Apple Inc. of Cupertino, California, the BlackBerry OS operating system distributed by Blackberry, Ltd. of Waterloo, Canada, and the Android operating system developed by Google, Inc. and the Open Handset Alliance, or the like. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A stroller comprising:
a frame having a shaft;
a seat depending from the frame;
a base removably attached to the frame by the shaft of the frame; and
wheels disposed on the base,
wherein the shaft of the frame is inserted into the base to allow the frame to rotate relative to the base.

2. The stroller of claim 1, further comprising a canopy that may be manually unfolded to extend from the seat.

3. The stroller of claim 2, further comprising a fan disposed on the canopy.

4. The stroller of claim 3, further comprising a solar panel disposed on the canopy and electrically connected to the fan.

5. The stroller of claim 2, further comprising a display device disposed on the canopy.

6. The stroller of claim 5, wherein the display device includes a screen and speakers.

7. The stroller of claim 5, wherein the display device includes a communication interface configured to facilitate wireless communication with a mobile device.

8. The stroller of claim 5, wherein the display device includes a camera.

9. The stroller of claim 1, further comprising a base with skis attachable to the frame when the base is removed.

10. A stroller comprising:
a frame;
a seat depending from the frame;
a base disposed on the frame;
a canopy that may be manually unfolded to extend from the seat; and
a display device incorporated into the canopy and viewable from the seat.

11. The stroller of claim 10, further comprising a solar panel disposed on the canopy and electrically connected to the display device.

12. The stroller of claim 10, wherein the display device includes a screen and speakers.

13. The stroller of claim 10, wherein the display device includes a communication interface configured to facilitate wireless communication with a mobile device.

14. The stroller of claim 13, wherein the display device is configured to display content based on signals received from the mobile device.

15. The stroller of claim 10, wherein the display device includes a camera.

16. The stroller of claim 15, wherein the display device is configured to display content based on signals received from the camera.

17. The stroller of claim 10, further comprising a cooling fan disposed on the canopy.

18. The stroller of claim 17, further comprising a solar panel disposed on the canopy and electrically connected to the cooling fan.

19. The stroller of claim 16, wherein the display device is configured to display entertainment and educational content based on signals received from an app on a mobile device.
